(19) United States
(12) Patent Application Publication
(10) Pub. No.: US 2021/0327399 A1
(43) Pub. Date: Oct. 21, 2021

(54) HYBRID AUDIO PROCESSING SYSTEM

(71) Applicant: Arnaldo Aguilera Pavon, Opa Locka, FL (US)

(72) Inventor: Arnaldo Aguilera Pavon, Opa Locka, FL (US)

(21) Appl. No.: 17/362,771

(22) Filed: Jun. 29, 2021

Related U.S. Application Data
(63) Continuation of application No. 63/079,956, filed on Sep. 17, 2020.

(51) Int. Cl. G10H 3/18; G10H 5/00; G10H 1/00

(52) U.S. Cl. CPC G10H 3/186; G10D 1/08; G10H 1/0083; G10H 5/002

(57) ABSTRACT

A hybrid audio processing system that includes a housing, an audio amplification unit, and one or more speakers. The housing has a cover member and a body member, the cover member pivotally coupled to the body member, wherein the body member has a void dimensioned and shaped to encase a musical instrument. The audio amplification unit is configured to amplify signals received from the musical instrument, the amplification unit housed within the housing, wherein one or more controls for the audio amplification unit are coupled to an outer surface of the housing. The one or more speakers can be mounted in a wall of the body member, wherein the one or more speakers are operably coupled to the audio amplification unit.

### CROSS-REFERENCE TO RELATED APPLICATIONS

This application claims priority from the U.S. provisional patent application Ser. No. 63/079,956, filed on Sep. 17, 2020, which is incorporated herein by reference in its entirety.

### FIELD OF INVENTION

The present invention relates to an audio amplifier, speakers, musical instrument cases, and more particularly, the present invention relates to a hybrid audio processing system.

### BACKGROUND

Musical instruments, such as electric guitar, bass guitar, or acoustic guitar are generally connected to an amplifier system to amplify the weak signals from a pickup on the guitar. The amplified signal can then be fed to loudspeakers. The amplifier system and the loudspeakers can be combined in a single housing, or the speakers can be standalone speakers housed in a wooden cabinet. Such audio processing systems are commercially available in different capacities with a range of features. However, the amplifier, speakers, and the musical instrument case can be bulky and troublesome to transport as well as to store. Also, separate transportation may generally be needed for the instruments which can become costly. Because of the aforesaid reasons, musicians face a lot of difficulties in carrying all the instruments, particularly for small events or get-togethers. The musicians cannot carry all these instruments all the time, so any urgent requirement without any prior information cannot be met by the musicians.

Thus, a long-term desire is there for an apparatus that can be compact and portable and can be used with the musical instrument for audio processing.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a hybrid audio processing system for musical instruments that is compact and portable.

It is another object of the present invention that the hybrid audio processing system can also encase the musical instrument for transport and storage.

It is still another object of the present invention that the hybrid audio processing system with the musical instrument can be carried by a musician in hand.

It is yet another object of the present invention that the hybrid audio processing system can protect the encased musical instrument.

It is a further object of the present invention that the hybrid audio processing system is economical to manufacture.

It is still a further object of the present invention that the hybrid audio processing system is light in weight.

In one aspect, disclosed is a hybrid audio processing system that can include a housing that has a cover member and a body member, the cover member pivotally coupled to the body member, wherein the body member has a void dimensioned and shaped to encase a musical instrument. The hybrid audio processing system can further include an audio amplification unit configured to amplify signals received from the musical instrument, the amplification unit housed within the housing, wherein one or more controls for the audio amplification unit are coupled to an outer surface of the housing. The hybrid audio processing system can further include one or more speakers mounted in a wall of the body member, wherein the one or more speakers are operably coupled to the audio amplification unit.

In one implementation of the hybrid audio processing system, the musical instrument can be a guitar, and wherein the hybrid audio processing system can further include one or more pockets for encasing one or more accessories of the guitar. the housing can be shaped similar to a shape of the guitar i.e., a broad curved body and a narrow neck. In one aspect, the outer surface of the void has a layer of microfiber cloth configured to prevent scratching of an outer surface of the guitar.

In one aspect, the cover member can be secured to the body member through a plurality of latches.

In one aspect, the audio amplification unit can be wire or wirelessly couple to the guitar.

In one aspect, the audio amplification unit and the one or more speakers are powered by a battery, the battery encased within the housing.

In one aspect, the one or more controls include volume level controls, bass control, treble control, wherein the hybrid audio processing system further includes one or more inputs including a phone jack.

In one aspect, the musical system is an electric guitar.

In one aspect, the hybrid audio processing system further includes 3-4 speakers that can be mounted to a rear wall of the body member.

These and other objects and advantages of the embodiments herein and the summary will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of the hybrid audio processing system, according to an exemplary embodiment of the present invention.

FIG. 2 is another view of the hybrid audio processing system showing the sides and bottom, according to an exemplary embodiment of the present invention.

FIG. 3 is an enlarged view of the bottom of the hybrid audio processing system showing a speaker grill and latches, according to an exemplary embodiment of the present invention.

FIG. 4 is an enlarged view of the hybrid audio processing system showing the controls, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

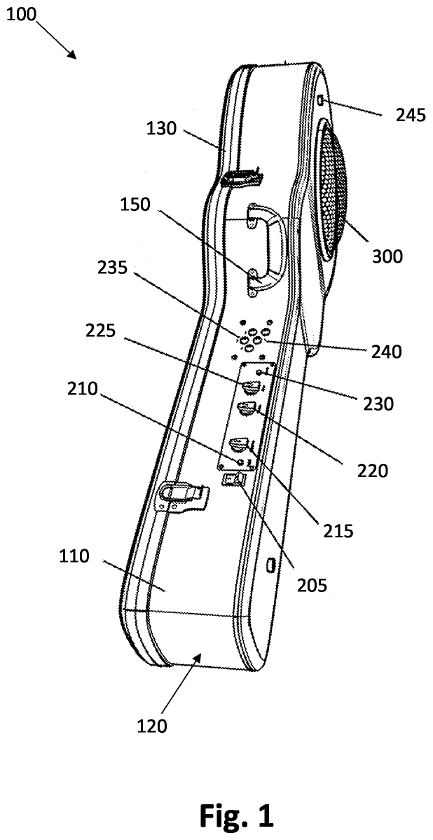

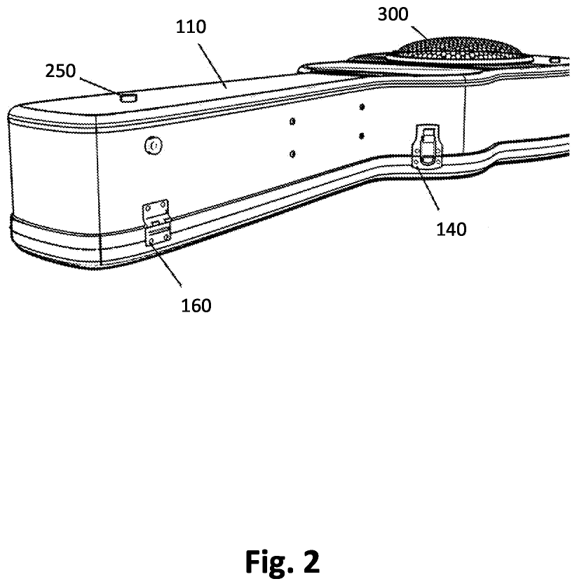

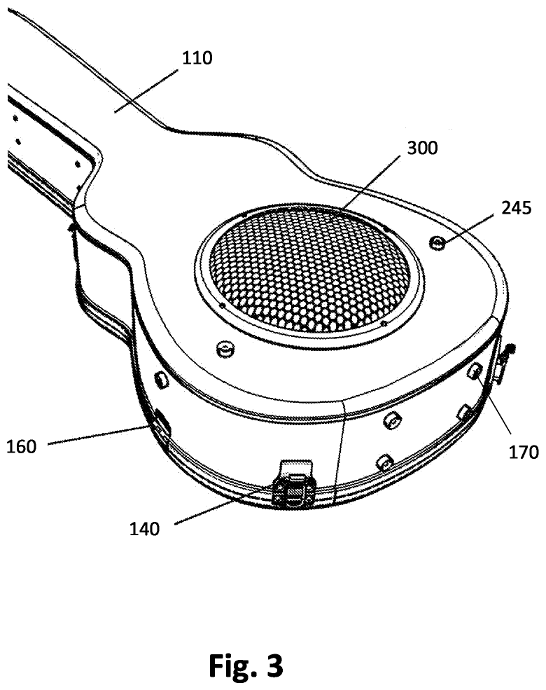

Disclosed is a hybrid audio processing system that can process signals from a musical instrument, such as amplifying the signals and broadcasting the amplified signals through speakers. Moreover, the disclosed hybrid audio processing system can also provide for encasing and protecting the musical instrument. Referring to FIGS. 1-4 which shows the disclosed hybrid audio processing system 100 for guitars, such as an electric guitar, bass guitar, and acoustic guitar. As can be seen in FIG. 1, the hybrid audio processing system 100 can include a housing 110, wherein the housing 110 can be of a shape of the guitar, similar to commercially available cases of the guitars. The housing 110 can be made of materials, such as wood and plastic that can be both durable and sturdy. The housing 110 can include a body member 120 and a cover member 130. The cover member 130 can be pivotally coupled to the body member 120, such as using hinge joints 160. The cover member 130 can be opened by lifting the cover for gaining access into a void in the body member 120. The void (not shown) can be of the dimension and shape of the guitar such as the guitar can be encased in the void. The guitar can be stored in the disclosed hybrid audio processing system 100 like the guitar cases. The outer surface of the void can be made of microfiber material that may not scratch the surface of the guitar encased in the void. Suitable paddings can also be provided to protect the guitar from any external impact. Additionally, space can be provided within the body member or the cover member for storing other accessories of the guitar. For example, additional pockets can be provided for the accessories. The cover member 130 can be secured to the body member 120 using latches 140. A handle 150 can also be provided coupled to the body member 120 for handling and transporting the hybrid audio processing system 100. The bottom of the housing can have plastic or rubber pads 170, as shown in FIG. 3, for keeping the hybrid audio processing system 100 upright and off the floor.

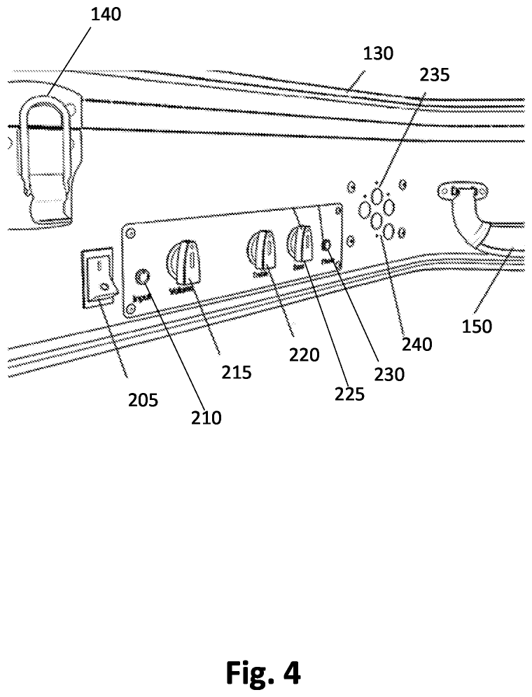

A suitable audio amplification unit can also be encased within the body member 120 of the housing 110. The audio amplification unit can be wired or wirelessly coupled to the guitar to receive the signals. If the guitar can be wired to the hybrid audio processing system, the wire can also be encased within the housing 110. The controls, inputs, and outputs of the audio amplification unit can be provided in a wall of the housing, such as the controls, inputs, and outputs can be accessed from outside of the hybrid audio processing system. FIGS. 1 and 4 show exemplary embodiments of the controls and inputs that are coupled to a side of the housing 110. A power button 205 can be seen mounted to an outer surface of the housing 110 at the side having the handle 150. The power button 205 can be operated for turning the power supply to the hybrid audio processing system 100 on and off. In one case, the disclosed hybrid audio processing system can be powered by a portable battery also encased within the housing. The battery can be a rechargeable battery or a one-time disposable battery. Any battery, such as a Lithium-ion battery can be used without departing from the scope of the present invention. Suitable charging points can also be provided in the housing for connecting to a power supply for charging the battery of the hybrid audio processing system. Alternatively, the hybrid audio processing system can also be powered by an external power supply.

The controls, inputs, and outputs are shown in FIGS. 1 and 4 can include an input jack 210, volume knob 215, treble knob 220, bass knob 225, phone jack 230, functional button 235, and drum machine 240 controls. It is to be understood that few controls and input are shown in FIGS. 1 and 4 are for illustration only, and not all the controls are essential for the operation of the disclosed hybrid audio processing system. Similarly, any other control or input or output that is known to a skilled person for use in musical instruments and audio processing systems can be incorporated without departing from the scope of the present invention. Also, the control can be provided at any other place in the housing, such as knobs 245 and 250 are shown on the rear face of the housing 110. Moreover, a display, such as a LED can also be coupled to an outer surface of the housing for displaying the values of controls.

One or more speakers 300 can also be mounted in a wall of the housing 110, wherein the housing can have a cut over which the speaker can be mounted. The speakers can be protected by the speaker grill, as shown in the drawings. FIG. 1 shows the rear side of the body member 120 has one speaker 300 while FIG. 3 shows an enlarged view of the speaker grill. More than one speaker including the components of the speaker can be suitable arranged in the housing and any such arrangement of the speakers and the components of the speaker are within the scope of the present invention. In one case, 3-4 speakers can be provided on the rear side of the housing. The speakers can also be powered by the battery encased within the housing or an external power supply.

Thus, disclosed is a compact and portable hybrid audio processing system that can encase the musical instrument and any accessories. The hybrid audio processing system with the encased musical instrument can be easily carried by a musician, for example in hand. The musician can handle the disclosed hybrid audio processing system using one hand by grasping the handle provided on side of the housing of the hybrid audio processing system. Additionally, a shoulder strap can also be provided for hanging the hybrid audio processing system through the shoulder.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A hybrid audio processing system comprising:
a housing that has a cover member and a body member, the cover member pivotally coupled to the body member, wherein the body member has a void dimensioned and shaped to encase a musical instrument;
an audio amplification unit configured to amplify signals received from the musical instrument, the audio amplification unit housed within the housing, wherein one or more controls for the audio amplification unit are coupled to an outer surface of the housing; and
one or more speakers mounted in a wall of the body member, wherein the one or more speakers are operably coupled to the audio amplification unit.

2. The hybrid audio processing system according to claim 1, wherein the musical instrument is a guitar.

3. The hybrid audio processing system according to claim 2, wherein the hybrid audio processing system further comprises:
one or more pockets for encasing one or more accessories of the guitar.

4. The hybrid audio processing system according to claim 2, wherein the housing is shaped similar to a shape of the guitar.

5. The hybrid audio processing system according to claim 2, wherein an outer surface of the void has a layer of microfiber cloth configured to prevent scratching of a surface of the guitar.

6. The hybrid audio processing system according to claim 2, wherein the cover member is secured to the body member through a plurality of latches.

7. The hybrid audio processing system according to claim 2, wherein the audio amplification unit is configured to wirelessly couple to the guitar.

8. The hybrid audio processing system according to claim 2, wherein the audio amplification unit and the one or more speakers are powered by a battery, the battery encased within the housing.

9. The hybrid audio processing system according to claim 1, wherein the one or more controls include volume level controls, bass control, treble control, wherein the hybrid audio processing system further comprises one or more inputs including a phone jack.

10. The hybrid audio processing system according to claim 1, wherein the musical instrument is an electric guitar.

11. The hybrid audio processing system according to claim 1, wherein 3-4 speakers are mounted to a rear wall of the body member.
